(19) United States
(12) Patent Application Publication
(10) Pub. No.: US 2006/0237056 A1
(43) Pub. Date: Oct. 26, 2006

(54) Pressurized apparatus for cleaning objects

(75) Inventors: Wei Shuo Lo, Taipei Hsien (TW); Yung Ho Chiu, Taipei Hsien (TW); Zui Yeh Lin, Taipei Hsien (TW); Wan Kuei Yao, Taipei Hsien (TW); Tzu Lung Ho, Taipei Hsien (TW); Kuei Chi Lee, Taipei Hsien (TW)

Correspondence Address: CHARLES E. BAXLEY, ESQ., 90 JOHN STREET, THIRD FLOOR, NEW YORK, NY, 10038, US

(73) Assignee: Tex-Ray Industrial Co., Ltd.

(21) Appl. No.: 11/075,318

(22) Filed: Mar. 8, 2005

(51) Int. Cl. B08B 9/00; B08B 3/12

(52) U.S. Cl. 134/166 R; 134/184

(57) ABSTRACT

A cleaning apparatus includes a working housing for receiving objects to be cleaned, a receptacle for supplying a pressurized fluid to the working housing, and a pump for pumping the pressurized fluid into the working housing, for removing releasing agents or solutions from the objects. A control valve is coupled between the pump and the working housing, to selectively close the working housing after the pressurized fluid has been pumped and supplied into the working housing to a predetermined pressure, and maintained within the working housing for a predetermined time interval. The agents or solutions may be removed from the objects after the pressurized fluid is drained out of the working housing.

### BACKGROUND OF THE INVENTION

1. Field of the Invention

The present invention relates to a cleaning apparatus, and more particularly to a pressurized cleaning apparatus for using various pressurized fluid or air or gas to clean various plastic or artificial objects having mold releasing agents or other releasing agents or solutions attached thereon, without cleaning solutions that may pollute our environment.

2. Description of the Prior Art

Typical workpieces, machine parts or elements, or plastic or artificial objects, such as shoe soles or shoe pads, may comprise mold releasing agents or other releasing agents or solutions attached thereon, which may be required to be cleaned or washed from the plastic or artificial objects.

Normally, for cleaning the plastic or artificial objects, a large quantity of acid or basic solutions or water is required to be provided and consumed and sprayed onto the objects, in order to clean or to wash the objects. However, some of the cleaning agents or solutions, such as trichloroethylene, trichloroethane, toluene, etc., may seriously pollute our environment and may hurt people and animals.

In addition, the typical cleaning agents or solutions may only be used to clean the outer peripheral portion of the plastic or artificial objects, but may not be used to suitably clean or wash the inner or interior portions of the plastic or artificial objects, due to surface tension which may prevent the typical cleaning agents or solutions from entering into the inner or interior portions of the plastic or artificial objects.

Furthermore, after the cleaning or washing operations, the objects will be wetted and may have the typical cleaning agents or solutions or water attached thereon, such that one or more additional air blowing processes may further be required to be conducted to dry the plastic or artificial objects, in order to remove the typical cleaning agents or solutions or water from the plastic or artificial objects. Accordingly, the typical workpieces, machine parts, or objects may not be easily cleaned by the conventional cleaning methods or devices.

The present invention has arisen to mitigate and/or obviate the afore-described disadvantages of the conventional objects cleaning methods or devices.

### SUMMARY OF THE INVENTION

The primary objective of the present invention is to provide a pressurized cleaning apparatus for using various pressurized fluid or air or gas to clean various plastic or artificial objects having mold releasing agents or other releasing agents or solutions attached thereon.

The other objective of the present invention is to provide a pressurized cleaning apparatus for cleaning various objects with pressurized fluid or gas, such as CO₂, that is highly spreadable and that is not sticky and that will not pollute our environment.

The further objective of the present invention is to provide a pressurized cleaning apparatus for cleaning various objects with pressurized fluid or gas, such as CO₂, that may be recycled and used again and again.

In accordance with one aspect of the invention, there is provided a pressurized cleaning apparatus comprising a working housing including a chamber formed therein for receiving objects to be cleaned and having agents or solutions attached thereon, and including a cover provided thereon, for opening and closing the chamber thereof, and for allowing the objects to be removed from or to be engaged into the chamber of the working housing, and including a drain valve coupled thereto for draining purposes, a receptacle for receiving a pressurized fluid therein, the receptacle being coupled to the working housing, a pump coupled between the working housing and the receptacle, for pumping the pressurized fluid into the working housing, for removing the agents from the objects, and a first control valve coupled between the pump and the working housing, to selectively close the working housing after the pressurized fluid has been pumped and supplied into the working housing to a predetermined pressure, and to maintain the pressurized fluid within the working housing for a predetermined time interval. The releasing agents or solutions may be separated or blown away from the objects when the drain valve of the working housing is opened and when the pressurized fluid flows out of the working housing in a fast speed.

The working housing includes a control device provided and attached thereto, for maintaining the chamber of the working housing within a predetermined temperature range and in a predetermined pressure range. A second control valve may further be provided and coupled between the pump and the receptacle, for controlling the pressurized fluid to flow from the receptacle to the pump.

A container may further be provided and coupled to the working housing, and includes a chamber formed therein to receive the pressurized fluid from the working housing, and to allow the agents to be separated from the pressurized fluid after the pressurized fluid have been received in the container for a predetermined time interval.

The container includes a second control valve provided and coupled between the working housing and the container, to control the pressurized fluid to flow from the working housing to the container. The container includes a drain valve coupled thereto for draining the agents. The container includes a control device attached thereto, for maintaining the chamber of the container within a predetermined temperature range and in a predetermined pressure range.

A second pump may further be provided and coupled between the container and the receptacle, for pumping the pressurized fluid to flow back from the container to the receptacle. Two second control valves may further be provided and disposed on opposite sides of the second pump, and coupled between the second pump and the container, and between the second pump and the receptacle respectively.

A second control valve may further be provided and coupled between the container and the receptacle, and disposed in parallel to the second pump, to allow the pressurized fluid to directly flow from the container back to the receptacle without through the second pump.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a plan and partial cross sectional view of a pressurized cleaning apparatus in accordance with the present invention;

FIG. 2 is a plan and partial cross sectional view similar to FIG. 1, illustrating a simplified embodiment of the pressurized cleaning apparatus; and

FIG. 3 is a further plan and partial cross sectional view similar to FIGS. 1 and 2, illustrating a further simplified embodiment of the pressurized cleaning apparatus.

### DETAILED DESCRIPTION OF THE PREFERRED EMBODIMENT

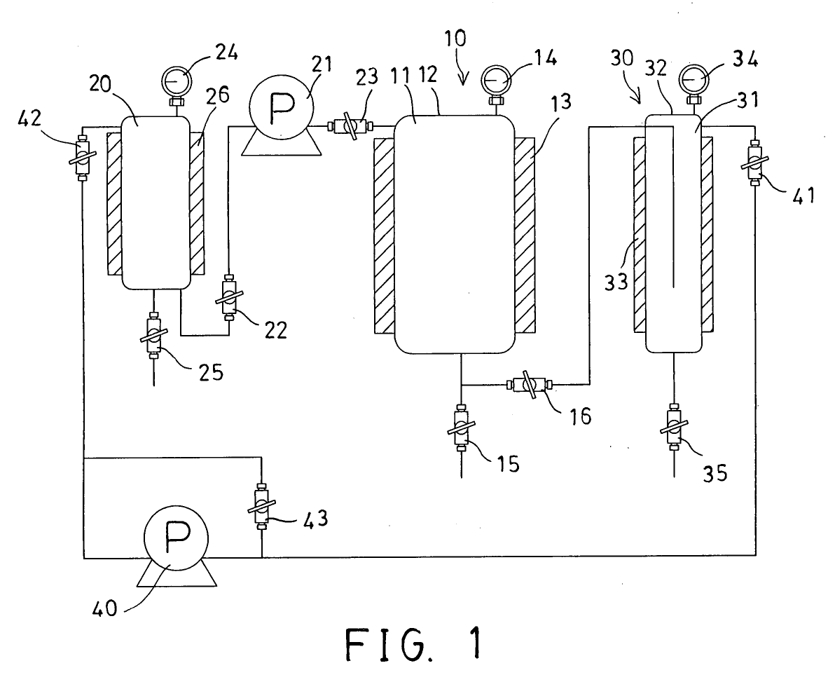

Referring to the drawings, and initially to FIG. 1, a pressurized cleaning apparatus in accordance with the present invention comprises a working housing 10 including a chamber 11 formed therein for receiving workpieces, machine parts, or objects, such as plastic or artificial objects, etc., that may comprise mold releasing agents or other releasing agents or solutions attached thereon, which may be required to be cleaned or washed from the plastic or artificial objects, and which may not be easily washed or cleaned by conventional cleaning devices or conventional water spraying methods.

The working housing 10 may include one or more doors or covers 12, such as an upper cover 12 provided thereon, for opening and closing the chamber 11 thereof, and for allowing the objects to be removed from or to be engaged into the chamber 11 of the working housing 10, and thus for allowing the objects to be cleaned within the chamber 11 of the working housing 10 by such as pressurized fluid or water or air or gas or the like, that is highly spreadable and not sticky, which will be discussed hereinafter.

For example, in the present invention, the fluid may be selected from either liquid or water or gas, and preferably, carbon dioxide CO₂ may be selected for cleaning the objects. A control device 13, such as a temperature control device 13 or a heater 13 may further be provided and attached onto the working housing 10, such as attached onto the outer peripheral portion of the working housing 10, for heating the pressurized fluid or CO₂ and the objects contained within the chamber 11 of the working housing 10, and for maintaining the chamber 11 of the working housing 10 in the temperature ranging from 4˜80° C., and in the pressure ranging from 10˜300 kg/cm².

A pressure gauge 14 may further be provided and attached or coupled to the working housing 10, such as attached to top of the working housing 10, to detect the pressure within the chamber 11 of the working housing 10. A drain valve 15 may further be provided and attached or coupled to the working housing 10, such as attached to bottom of the working housing 10, to allow the fluid or CO₂ or the like to be drained or removed from the chamber 11 of the working housing 10.

A pressurized fluid reservoir or receptacle 20 may further be provided for receiving or storing the pressurized fluid or CO₂ or the like therein, and may be coupled to the working housing 10 via a pump 21 and one or more, such as two control valves 22, 23 that may be disposed or coupled on different or opposite sides of the pump 21. For example, the control valve 22 and the pump 21 and the other control valve 23 may be disposed or coupled in series between the receptacle 20 and the working housing 10, for pumping and/or controlling the pressurized fluid or CO₂ or the like from the receptacle 20 to the working housing 10.

A pressure gauge 24 may further be provided and attached or coupled to the receptacle 20, such as attached to top of the receptacle 20, to detect the pressure within the receptacle 20. A drain valve 25 may further be provided and attached or coupled to the receptacle 20, such as attached to bottom or top of the receptacle 20, to allow the pressurized fluid or CO₂ or the like to be drained or removed from the receptacle 20.

A control device 26, such as a temperature control device 26 or a heater 26 may further be provided and attached onto the receptacle 20, such as attached onto the outer peripheral portion of the receptacle 20, for heating the pressurized fluid or CO₂ contained within the receptacle 20, and for maintaining the receptacle 20 in the pressure ranging from 10˜150 kg/cm². The pump 21 may be used to pump the pressurized fluid or CO₂ or the like from the receptacle 20 to the working housing 10 to a pressure ranging from 10˜300 kg/cm², for example.

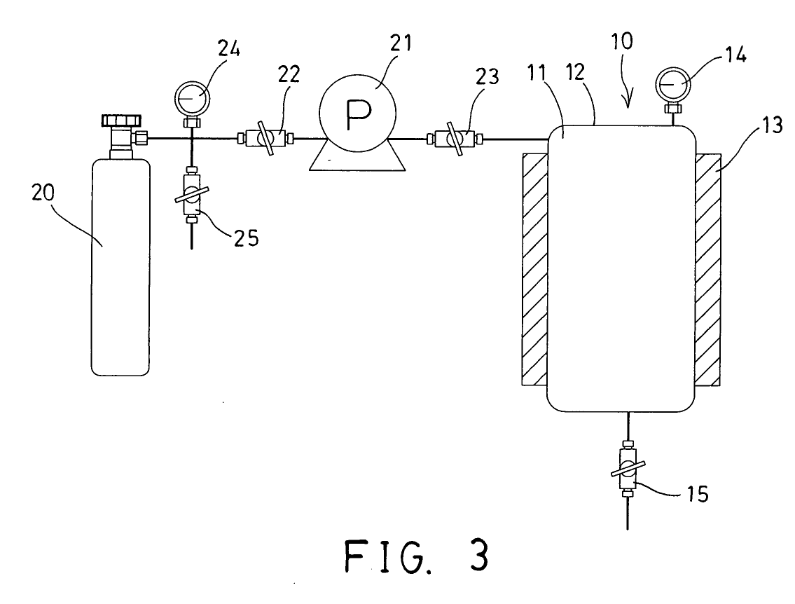

In operation, as shown in FIGS. 1-3, the objects, such as the plastic or artificial objects, to be cleaned may be engaged into the chamber 11 of the working housing 10 via such as the upper cover 12 of the working housing 10. The drain valve 15 is closed to prevent the fluid from leaking from the working housing 10. The working housing 10, such as the chamber 11 of the working housing 10 may preferably be maintained in a temperature ranging from 35˜65° C.±1° C., and the receptacle 20 is preferably be maintained in a temperature ranging from 2˜4° C.±1° C.

The control valves 22, 23 are then opened, to allow the pressurized fluid or CO₂ or the like to flow from the receptacle 20 to the working housing 10. The pump 21 is then energized or operated to pump the pressurized fluid or CO₂ or the like to flow from the receptacle 20 to the working housing 10, until the pressure within the chamber 11 of the working housing 10 reaching about 200 kg/cm², in which the pressure may be detected and shown by the pressure gauge 14.

After the pressure within the chamber 11 of the working housing 10 reaches about 30˜120 kg/cm², the pump 21 and the control valves 22, 23 are then shut off or closed, to prevent the pressurized fluid or CO₂ or the like from flowing from the receptacle 20 to the working housing 10 again, and to maintain the pressure in about 30˜120 kg/cm². The chamber 11 of the working housing 10 is preferably maintained in about 30˜120 kg/cm² for a predetermined time interval ranging from five (5) to ten (10) minutes, to allow the pressurized fluid or CO₂ or the like to penetrate or permeate or to be forced into the plastic or artificial objects.

After the predetermined time interval is accomplished or reached, the drain valve 15 may then be opened to allow the pressurized fluid or CO₂ or the like to drain or to flow out of the chamber 11 of the working housing 10. It is to be noted that, when the drain valve 15 is opened, the pressurized fluid or CO₂ or the like may flow out of the chamber 11 of the working housing 10 and may flow out through the drain valve 15 in a fast speed, to blow and to remove the dirt or particles or contaminants or oil or grease or other solutions or agents from the objects, and thus to allow the objects to be suitably cleaned.

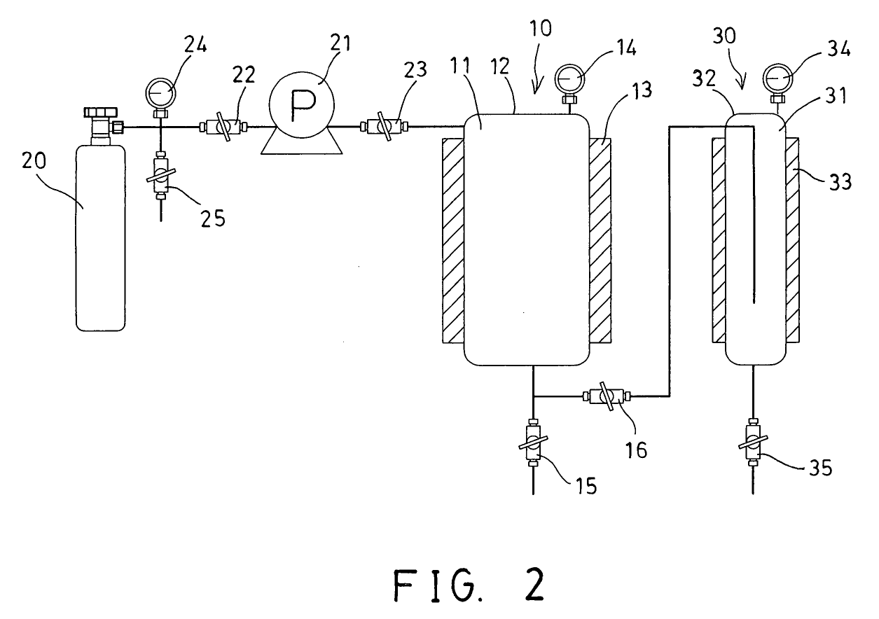

As shown in FIGS. 1 and 2, for receiving and recycling the pressurized fluid or CO₂ and/or for separating the dirt or particles or contaminants or oil or grease or other solutions from the pressurized fluid or CO₂, a container 30 may further be provided and also includes a chamber 31 formed therein to receive the pressurized fluid or CO₂ and the dirt or particles or contaminants or oil or grease or other solutions or agents from the working housing 10, and coupled to the working housing 10, particularly coupled to the bottom portion of the working housing 10 via another control valve 16 which may control the pressurized fluid or CO₂ and the dirt or particles or contaminants or oil or grease or other solutions or releasing agents to flow from the working housing 10 to the container 30.

The container 30 may include one or more doors or covers 32, such as an upper cover 32 provided thereon, for opening and closing the chamber 31 thereof, and for allowing the chamber 31 of the container 30 to be reached or cleaned, for example. A control device 33, such as a temperature control device 33 or a heater 33 may further be provided and attached onto the container 30, such as attached onto the outer peripheral portion of the container 30, for heating the fluid or CO₂ contained within the chamber 31 of the container 30, and for maintaining the chamber 31 of the container 30 in the temperature ranging from 4˜80° C., and in the pressure ranging from 10˜300 kg/cm².

A pressure gauge 34 may further be provided and attached or coupled to the container 30, such as attached to top of the container 30, to detect the pressure within the chamber 31 of the container 30. A drain valve 35 may further be provided and attached or coupled to the container 30, such as attached to bottom of the container 30, to allow the dirt or particles or contaminants or oil or grease or other solutions or agents contained or collected in the bottom of the container 30 to be drained out or removed from the chamber 31 of the container 30.

For example, after the pressurized fluid or CO₂ and the dirt or particles or contaminants or oil or grease or other solutions or agents have been flown from the working housing 10 to the container 30 and retained within the chamber 31 of the container 30 for a predetermined time interval, such as ranging from five (5) to ten (10) minutes, to allow the dirt or particles or contaminants or oil or grease or other solutions or agents to be separated from the pressurized fluid or CO₂ and to be dropped downwardly and collected within the bottom of the chamber 31 of the container 30, and then to be drained out or removed from the chamber 31 of the container 30 via the drain valve 35.

For recycling the pressurized fluid or CO₂, another pump 40 (FIG. 1) may further be provided and coupled between the receptacle 20 and the container 30, and one or more, such as two control valves 41, 42 may further be provided and disposed or coupled on different or opposite sides of the pump 40. For example, the control valve 41 may be disposed or coupled between the pump 40 and the container 30, and the other control valve 42 may be disposed or coupled between the pump 40 and the receptacle 20, for pumping and/or for controlling the pressurized fluid or CO₂ or the like to flow or to recycle from the container 30 back to the receptacle 20.

In operation, as shown in FIG. 1, after the pressurized fluid or CO₂ and the dirt or particles or contaminants or oil or grease or other solutions or agents have been retained within the chamber 31 of the container 30 for a predetermined time interval and after the dirt or particles or contaminants or oil or grease or other solutions or agents have been separated from the pressurized fluid or CO₂ and dropped downwardly and collected within the bottom of the chamber 31 of the container 30, and/or have been drained out or removed from the chamber 31 of the container 30 via the drain valve 35, the pressurized fluid or CO₂ will have no dirt or particles or contaminants or oil or grease or other solutions or agents contained therein, and may thus be recycled back to the receptacle 20, by opening the control valves 41, 42, and/or by energizing or operating the pump 40.

An additional control valve 43 may further be provided and disposed or coupled between the receptacle 20 and the container 30, or coupled between the control valves 41, 42, and disposed or coupled in parallel to the pump 40, to allow the pressurized fluid or CO₂ to directly flow from the container 30 back to the receptacle 20 without through the pump 40. For example, the control valve 43 may be opened to allow the pressurized fluid or CO₂ to directly flow from the container 30 back to the receptacle 20 by the pressure of the pressurized fluid or CO₂, and the pump 40 may be energized or operated to pump the pressurized fluid or CO₂ from the container 30 back to the receptacle 20, after the pressure of the pressurized fluid or CO₂ has been dropped to a predetermined low pressure that may not be used to force the pressurized fluid or CO₂ to back to the receptacle 20.

It is to be noted that the pressurized fluid or gas, such as CO₂, will not pollute our environment, and may be recycled and used again and again.

Accordingly, the pressurized cleaning apparatus in accordance with the present invention may thus be provided for cleaning various objects that include mold releasing agents or other releasing agents or solutions attached thereon, without cleaning solutions that may pollute our environment, and that may not be easily cleaned by the other cleaning devices or methods.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A pressurized cleaning apparatus comprising:
a working housing including a chamber formed therein for receiving objects to be cleaned and having agents or solutions attached thereon, and including a cover provided thereon, for opening and closing said chamber thereof, and for allowing the objects to be removed from or to be engaged into said chamber of said working housing, and including a drain valve coupled thereto for draining purposes,
a receptacle for receiving a pressurized fluid therein, said receptacle being coupled to said working housing,
a pump coupled between said working housing and said receptacle, for pumping the pressurized fluid into said working housing, for removing the agents from the objects, and
a first control valve coupled between said pump and said working housing, to selectively close said working housing after the pressurized fluid has been pumped and supplied into said working housing to a predetermined pressure, and to maintain the pressurized fluid within said working housing for a predetermined time interval.

2. The pressurized cleaning apparatus as claimed in claim 1, wherein said working housing includes a control device provided and attached thereto, for maintaining said chamber of said working housing within a predetermined temperature range and in a predetermined pressure range.

3. The pressurized cleaning apparatus as claimed in claim 1 further comprising a second control valve coupled between said pump and said receptacle, for controlling the pressurized fluid from said receptacle to said pump.

4. The pressurized cleaning apparatus as claimed in claim 1 further comprising a container coupled to said working housing, and including a chamber formed therein to receive the pressurized fluid from said working housing, and to allow the agents to be separated from the pressurized fluid after the pressurized fluid have been received in said container for a predetermined time interval.

5. The pressurized cleaning apparatus as claimed in claim 4, wherein said container includes a second control valve provided and coupled between said working housing and said container, to control the pressurized fluid to flow from said working housing to said container.

6. The pressurized cleaning apparatus as claimed in claim 4, wherein said container includes a drain valve coupled thereto for draining the agents.

7. The pressurized cleaning apparatus as claimed in claim 4, wherein said container includes a control device attached thereto, for maintaining said chamber of said container within a predetermined temperature range and in a predetermined pressure range.

8. The pressurized cleaning apparatus as claimed in claim 1 further comprising a second pump coupled between said container and said receptacle, for pumping the pressurized fluid to flow back from said container to said receptacle.

9. The pressurized cleaning apparatus as claimed in claim 8 further comprising two second control valves disposed on opposite sides of said second pump, and coupled between said second pump and said container, and between said second pump and said receptacle respectively.

10. The pressurized cleaning apparatus as claimed in claim 1 further comprising a second control valve coupled between said container and said receptacle, and disposed in parallel to said second pump, to allow the pressurized fluid to directly flow from said container back to said receptacle without through said second pump.
